(19) United States
(12) Patent Application Publication
(10) Pub. No.: US 2026/0160250 A1
(43) Pub. Date: Jun. 11, 2026

(54) SCROLL COMPRESSOR

(71) Applicant: KABUSHIKI KAISHA TOYOTA JIDOSHOKKI, Kariya-shi (JP)

(72) Inventors: Yuya HATTORI, Kariya-shi (JP); Yoshihiko SATO, Kariya-shi (JP); Kai INATSU, Kariya-shi (JP)

(73) Assignee: KABUSHIKI KAISHA TOYOTA JIDOSHOKKI, Kariya-shi (JP)

(21) Appl. No.: 19/404,261

(22) Filed: Dec. 1, 2025

(30) Foreign Application Priority Data
Dec. 6, 2024 (JP) 2024-213353

(51) Int. Cl. F04C 18/02; F04C 29/00; F04C 29/02; F16C 17/02; F16C 33/10

(52) U.S. Cl. CPC F04C 18/0215; F04C 29/0057; F04C 29/02; F16C 17/02; F16C 33/1045; F04C 2240/30; F04C 2240/50

(57) ABSTRACT

A scroll compressor includes a housing, a rotary shaft, and a compression mechanism. The rotary shaft has an eccentric shaft. The compression mechanism has a compression chamber. The housing has a shaft supporting housing. Refrigerant is introduced into a back pressure chamber. The orbiting scroll has an oil supply hole. The eccentric shaft is inserted into a bushing. The bushing has a bushing tubular portion and a bushing flange portion. The plain bearing has a bearing tubular portion and a bearing flange portion. A groove is formed in the bearing tubular portion. A cutout through which the oil is supplied toward an outer peripheral edge of the bearing flange portion is formed in the bearing flange portion and communicates with the groove.

### CROSS-REFERENCE TO RELATED APPLICATION

This application claims priority to Japanese Patent Application No. 2024-213353 filed on Dec. 6, 2024, the entire disclosure of which is incorporated herein by reference.

### BACKGROUND ART

The present disclosure relates to a scroll compressor.

The scroll compressor includes a housing, a rotary shaft, and a compression mechanism. The housing has a suction port and a discharge port. A refrigerant is sucked through the suction port. The refrigerant is discharged through the discharge port. The rotary shaft is accommodated in the housing. The rotary shaft is rotatably supported by the housing. The rotary shaft has an eccentric shaft. The eccentric shaft protrudes from a distal end of the rotary shaft. The eccentric shaft extends in parallel to the rotary shaft at a position offset from a center axial line of the rotary shaft.

The compression mechanism has a fixed scroll and an orbiting scroll. The fixed scroll is fixed to the housing. The fixed scroll has a fixed scroll base plate, a fixed scroll spiral wall, and a fixed scroll outer peripheral wall. The fixed scroll spiral wall protrudes from the fixed scroll base plate. The fixed scroll outer peripheral wall protrudes from the fixed scroll base plate and surrounds the fixed scroll spiral wall. The orbiting scroll orbits with rotation of the rotary shaft. The orbiting scroll has an orbiting scroll base plate and an orbiting scroll spiral wall. The orbiting scroll base plate faces the fixed scroll base plate. The orbiting scroll spiral wall protrudes from the orbiting scroll base plate toward the fixed scroll base plate and orbits inside the fixed scroll outer peripheral wall.

A compression chamber is formed in the compression mechanism. The compression chamber is defined by the fixed scroll base plate, the fixed scroll spiral wall, the orbiting scroll base plate, and the orbiting scroll spiral wall. The refrigerant sucked into the compression chamber is compressed by meshing the fixed scroll spiral wall with the orbiting scroll spiral wall.

The housing has a shaft supporting housing. The shaft supporting housing is disposed on a side opposite from the fixed scroll base plate relative to the orbiting scroll base plate. The shaft supporting housing supports the rotary shaft. A back pressure chamber is formed between the shaft supporting housing and a base plate end surface of the orbiting scroll base plate opposite from the fixed scroll base plate. The refrigerant for urging the orbiting scroll base plate toward the fixed scroll base plate is introduced into the back pressure chamber. An oil supply hole is formed in the orbiting scroll. The oil supply hole is opened toward the back pressure chamber and oil is supplied to the back pressure chamber through the oil supply hole.

The eccentric shaft is inserted into a bushing. The bushing is swingable about the eccentric shaft. A recess having a bottomed tubular shape is formed in the base plate end surface. The bushing is disposed in the recess. The oil supply hole is opened in a bottom surface that defines the recess.

For example, as disclosed in Japanese Patent Application Publication No. 2014-173436, a plain bearing is disposed on an inner peripheral surface that defines the recess. The plain bearing rotatably supports the bushing. The bushing has a bushing tubular portion that is formed in a tubular shape and disposed inside the plain bearing. The plain bearing has a bearing tubular portion that is disposed on the inner circumferential surface of the recess.

In such a scroll compressor, the bushing may move toward the orbiting scroll in an axial direction of the rotary shaft between the distal end of the rotary shaft and the orbiting scroll. When the bushing moves toward the orbiting scroll in the axial direction of the rotary shaft between the rotary shaft and the orbiting scroll, the bushing may come into contact with the orbiting scroll. The contact of the bushing with the orbiting scroll causes abrasion between the orbiting scroll and the bushing, which reduces durability of the scroll compressor.

Here, for example, it is considered to separately provide a component for restricting the movement of the bushing toward the orbiting scroll in the axial direction of the rotary shaft and to separately provide a component with high abrasion resistance between the bushing and the orbiting scroll in the axial direction of the rotary shaft, other than the plain bearing. However, these are not preferable because the number of the components increases. Accordingly, it has been desired to improve the durability of the scroll compressor without increasing the number of components.

### SUMMARY

In accordance with an aspect of the present disclosure, there is provided a scroll compressor that includes a housing having a suction port through which a refrigerant is sucked and a discharge port through which the refrigerant is discharged, a rotary shaft accommodated in the housing and rotatably supported by the housing, and a compression mechanism having a fixed scroll that is fixed to the housing and an orbiting scroll that orbits with rotation of the rotary shaft. The rotary shaft has an eccentric shaft that protrudes from a distal end of the rotary shaft and extends in parallel with the rotary shaft at a position offset from a center axial line of the rotary shaft. The fixed scroll has a fixed scroll base plate, a fixed scroll spiral wall that protrudes from the fixed scroll base plate, and a fixed scroll outer peripheral wall that protrudes from the fixed scroll base plate and surrounds the fixed scroll spiral wall. The orbiting scroll has an orbiting scroll base plate that faces the fixed scroll base plate and an orbiting scroll spiral wall that protrudes from the orbiting scroll base plate toward the fixed scroll base plate and orbits inside the fixed scroll outer peripheral wall. The compression mechanism has a compression chamber that is defined by the fixed scroll base plate, the fixed scroll spiral wall, the orbiting scroll base plate, and the orbiting scroll spiral wall and in which the refrigerant is compressed by meshing the fixed scroll spiral wall with the orbiting scroll spiral wall. The housing has a shaft supporting housing that is disposed on a side opposite from the fixed scroll base plate relative to the orbiting scroll base plate and supports the rotary shaft. The refrigerant is introduced into a back pressure chamber that is formed between a base plate end surface of the orbiting scroll base plate opposite from the fixed scroll base plate and the shaft supporting housing, the refrigerant urging the orbiting scroll base plate toward the fixed scroll base plate. The orbiting scroll has an oil supply hole that is opened toward the back pressure chamber and through which oil is supplied to the back pressure chamber. The eccentric shaft is inserted into a bushing that is swingable about the eccentric shaft. The base plate end surface has a recess formed in a bottom tubular shape in which the bushing is disposed. The recess is defined by an inner peripheral surface on which a plain bearing rotatably supporting the bushing is disposed. The recess is defined by a bottom surface in which the oil supply hole is opened. The bushing has a bushing tubular portion that is disposed inside the plain bearing. The plain bearing has a bearing flange portion that protrudes from the bearing tubular portion outwardly in the radial direction and that is disposed between the base plate end surface and the bushing flange portion. A groove is formed in the bearing tubular potion and extends so that the oil is supplied from the oil supply hole toward the bearing flange portion through the groove. A cutout through which the oil is supplied toward an outer peripheral edge of the bearing flange portion is formed in the bearing flange portion and communicates with the groove.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view of a scroll compressor according to an embodiment;

FIG. 2 is an enlarged cross-sectional view illustrating a part of the scroll compressor;

FIG. 3 is a perspective view illustrating an orbiting scroll and a plain bearing;

FIG. 4 is a perspective view illustrating the orbiting scroll and the plain bearing;

FIG. 5 is a front view illustrating the orbiting scroll and the plain bearing; and

FIG. 6 is an enlarged cross-sectional view illustrating a part of a scroll compressor according to a modified example.

### DETAILED DESCRIPTION OF THE EMBODIMENTS

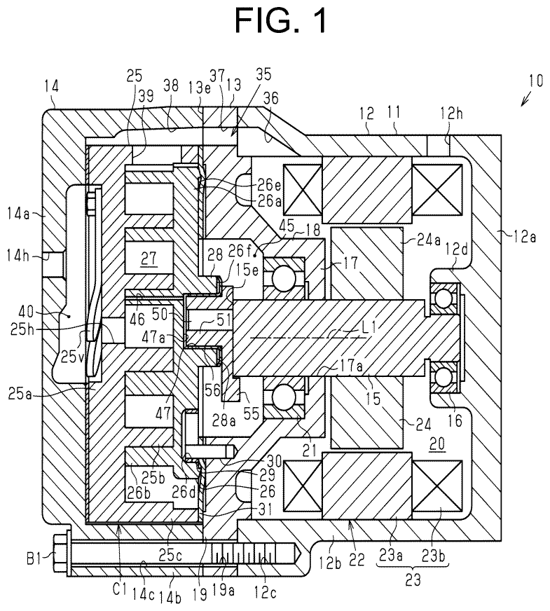

The following will describe an embodiment of a scroll compressor with reference to FIGS. 1 to 5. The scroll compressor in the present embodiment is, for example, used in a vehicle air conditioner.

### Basic Configuration of Scroll Compressor

As illustrated in FIG. 1, the scroll compressor 10 includes a housing 11 formed in a tubular shape. The housing 11 has a motor housing 12, a shaft supporting housing 13, and a discharge housing 14. The motor housing 12, the shaft supporting housing 13, and the discharge housing 14 are made of metal, such as aluminum. The scroll compressor 10 also includes a rotary shaft 15. The rotary shaft 15 is accommodated in the housing 11.

The motor housing 12 has an end wall 12a formed in a plate shape and a peripheral wall 12b formed in a tubular shape. The peripheral wall 12b is formed in the tubular shape extending from an outer peripheral portion of the end wall 12a. An axial direction of the peripheral wall 12b coincides with an axial direction of the rotary shaft 15. The motor housing 12 has a plurality of internal screw holes 12c. The internal screw holes 12c are formed in an open end of the peripheral wall 12b. Note that FIG. 1 illustrates only one of the internal screw holes 12c for the sake of description. The motor housing 12 also has a suction port 12h. That is, the housing 11 has the suction port 12h. A refrigerant is sucked through the suction port 12h. The suction port 12h is formed in a portion of the peripheral wall 12b that is located closer to the end wall 12a. An inside of the motor housing 12 and an outside of the motor housing 12 communicate with each other through the suction port 12h.

The motor housing 12 has a bearing holding portion 12d formed in a cylindrical shape. The bearing holding portion 12d protrudes from a center portion of an inner surface of the end wall 12a. A first end portion of the rotary shaft 15, which is one end portion of the rotary shaft 15 in the axial direction thereof, is inserted into the bearing holding portion 12d. The scroll compressor 10 includes a bearing 16. The bearing 16 is, for example, a roller bearing. The bearing 16 is provided between an inner peripheral surface of the bearing holding portion 12d and an outer peripheral surface of the first end portion of the rotary shaft 15. The first end portion of the rotary shaft 15 is rotatably supported by the motor housing 12 through the bearing 16.

The shaft supporting housing 13 has an end wall 17 formed in a plate shape and a peripheral wall 18 formed in a tubular shape. The peripheral wall 18 is formed in the tubular shape extending from an outer peripheral portion of the end wall 17. An axial direction of the peripheral wall 18 coincides with the axial direction of the rotary shaft 15. In addition, the shaft supporting housing 13 has a flange wall 19 formed in an annular shape. The flange wall 19 extends outwardly in a radial direction of the rotary shaft 15 from an end of the outer peripheral surface of the peripheral wall 18 opposite from the end wall 17.

The shaft supporting housing 13 has an insertion hole 17a formed in a circular hole shape. The insertion hole 17a is formed in a center portion of the end wall 17. The insertion hole 17a extends through the end wall 17 in a thickness direction thereof. The rotary shaft 15 is inserted through the insertion hole 17a. A distal end 15e in a second end portion of the rotary shaft 15, which is the other end portion of the rotary shaft 15 in the axial direction thereof, is located inside the peripheral wall 18.

The scroll compressor 10 includes a bearing 21. The bearing 21 is, for example, a roller bearing. The bearing 21 is provided between an inner peripheral surface of the peripheral wall 18 and an outer peripheral surface of the rotary shaft 15. The rotary shaft 15 is rotatably supported by the shaft supporting housing 13 through the bearing 21. That is, the shaft supporting housing 13 rotatably supports the rotary shaft 15. Thus, the rotary shaft 15 is rotatably supported by the housing 11.

The shaft supporting housing 13 has a plurality of bolt insertion holes 19a. The bolt insertion holes 19a are formed in an outer peripheral portion of the flange wall 19. The bolt insertion holes 19a extend through the flange wall 19 in a thickness direction thereof. Each of the bolt insertion holes 19a of the flange wall 19 communicates with a corresponding one of the internal screw holes 12c of the motor housing 12. Note that FIG. 1 illustrates only one of the bolt insertion holes 19a for the sake of description.

The scroll compressor 10 includes a motor chamber 20. The motor chamber 20 is defined by the motor housing 12 and the shaft supporting housing 13. The motor housing 12 defines the motor chamber 20 together with shaft supporting housing 13. Thus, the motor chamber 20 is formed in the housing 11. The motor chamber 20 communicates with the suction port 12h. The refrigerant is sucked into the motor chamber 20 through the suction port 12h. Accordingly, the motor chamber 20 is a region at a suction pressure.

The scroll compressor 10 includes a motor 22. The motor 22 is accommodated in the motor chamber 20. The motor 22 includes a stator 23 formed in a tubular shape and a rotor 24 formed in a tubular shape. The rotor 24 is disposed inside the stator 23. The rotor 24 rotates together with the rotary shaft 15. The stator 23 surrounds the rotor 24. The rotor 24 has a rotor core 24a fixed to the rotary shaft 15 and a plurality of permanent magnets, which is not illustrated, provided in the rotor core 24a.

The stator 23 has a stator core 23a formed in a tubular shape and a motor coil 23b. The stator core 23a is fixed to an inner peripheral surface of the peripheral wall 12b of the motor housing 12. The motor coil 23b is wound around the stator core 23a. Power controlled by an inverter, which is not illustrated, is supplied to the motor coil 23b, thereby rotating the rotor 24. As a result, the rotary shaft 15 rotates integrally with the rotor 24. Thus, the motor 22 rotates the rotary shaft 15.

The scroll compressor 10 includes a compression mechanism C1. The compression mechanism C1 has a fixed scroll 25 and an orbiting scroll 26. That is, the scroll compressor 10 includes the fixed scroll 25 and the orbiting scroll 26. The compression mechanism C1 is of a scroll type. The orbiting scroll 26 orbits relative to the fixed scroll 25 with the rotation of the rotary shaft 15.

The fixed scroll 25 has a fixed scroll base plate 25a, a fixed scroll spiral wall 25b, and a fixed scroll outer peripheral wall 25c. The fixed scroll base plate 25a is formed in a circular plate shape. A discharge port 25h is formed at a center of the fixed scroll base plate 25a. The discharge port 25h is formed in a circular hole shape. The discharge port 25h extends through the fixed scroll base plate 25a in a thickness direction thereof. The fixed scroll spiral wall 25b protrudes from the fixed scroll base plate 25a. The fixed scroll outer peripheral wall 25c protrudes from an outer peripheral portion of the fixed scroll base plate 25a. The fixed scroll outer peripheral wall 25c surrounds the fixed scroll spiral wall 25b.

The scroll compressor 10 includes a valve mechanism 25v. The valve mechanism 25v is attached to a surface of the fixed scroll base plate 25a opposite from the fixed scroll spiral wall 25b. The valve mechanism 25v is formed so as to be capable of opening and closing the discharge port 25h.

The orbiting scroll 26 has an orbiting scroll base plate 26a and an orbiting scroll spiral wall 26b. The orbiting scroll base plate 26a is formed in a circular plate shape. The orbiting scroll base plate 26a faces the fixed scroll base plate 25a. The orbiting scroll spiral wall 26b protrudes from the orbiting scroll base plate 26a toward the fixed scroll base plate 25a. The orbiting scroll spiral wall 26b meshes with the fixed scroll spiral wall 25b. The orbiting scroll 26 is located inside the fixed scroll outer peripheral wall 25c. The orbiting scroll 26 orbits inside the fixed scroll outer peripheral wall 25c. That is, the orbiting scroll spiral wall 26b orbits inside the fixed scroll outer peripheral wall 25c. A distal end surface of the fixed scroll spiral wall 25b is in contact with the orbiting scroll base plate 26a. A distal end surface of the orbiting scroll spiral wall 26b is in contact with the fixed scroll base plate 25a.

A compression chamber 27 is formed in the compression mechanism C1. The compression chamber 27 is defined by the fixed scroll base plate 25a, the fixed scroll spiral wall 25b, the orbiting scroll base plate 26a, and the orbiting scroll spiral wall 26b. Accordingly, the compression chamber 27 is defined between the fixed scroll 25 and the orbiting scroll 26. The refrigerant sucked into the compression chamber 27 is compressed by the meshing of the fixed scroll spiral wall 25b with the orbiting scroll spiral wall 26b.

The orbiting scroll base plate 26a has a boss portion 28. The boss portion 28 protrudes from a first surface 26e that is a surface of the orbiting scroll base plate 26a opposite from the fixed scroll base plate 25a. The boss portion 28 protrudes from a center portion of the first surface 26e toward the shaft supporting housing 13. The shaft supporting housing 13 is disposed on a side opposite from the fixed scroll base plate 25a relative to the orbiting scroll base plate 26a. An axial direction of the boss portion 28 coincides with the axial direction of the rotary shaft 15. The first surface 26e and a distal end surface 28a of the boss portion 28 form a base plate end surface 26f of the orbiting scroll base plate 26a that is an end surface opposite from the fixed scroll base plate 25a. An inside of the boss portion 28 corresponds to a recess 47 formed in the base plate end surface 26f. Thus, the recess 47 having a bottomed tubular shape is formed in the base plate end surface 26f.

The orbiting scroll base plate 26a has a plurality of groove portions 26d. The plurality of the groove portions 26d is formed around the boss portion 28 in the first surface 26e of the orbiting scroll base plate 26a. The plurality of groove portions 26d is arranged at predetermined intervals in a circumferential direction of the rotary shaft 15. Note that FIG. 1 illustrates only one of the groove portions 26d for the sake of description. Annular ring members 29 are each fitted in a corresponding one of the groove portions 26d. Pins 30 are each inserted into a corresponding one of the ring members 29. The pins 30 extend out from an end surface 13e of the shaft supporting housing 13 that is closer to the orbiting scroll 26.

The scroll compressor 10 includes an elastic plate 31. The elastic plate 31 is formed in an annular shape. The elastic plate 31 is held between the end surface 13e of the shaft supporting housing 13 and an open end surface of the fixed scroll outer peripheral wall 25c. The elastic plate 31 always urges the orbiting scroll 26 toward the fixed scroll 25.

The discharge housing 14 has an end wall 14a having a plate shape and a peripheral wall 14b having a tubular shape. The peripheral wall 14b has the tubular shape extending from an outer peripheral portion of the end wall 14a. An axial direction of the peripheral wall 14b coincides with the axial direction of the rotary shaft 15. The peripheral wall 14b surrounds the fixed scroll 25. Accordingly, the fixed scroll 25 is accommodated in the housing 11.

The discharge housing 14 has a plurality of bolt insertion holes 14c. The bolt insertion holes 14c are formed in the peripheral wall 14b. Note that FIG. 1 illustrates only one of the bolt insertion holes 14c for the sake of description. The bolt insertion holes 14c communicate with the corresponding bolt insertion holes 19a of the flange wall 19.

Bolts B1 inserted through the corresponding bolt insertion holes 14c are inserted through the corresponding bolt insertion holes 19a of the flange wall 19, and then, are screwed to the corresponding internal screw holes 12c of the motor housing 12. With these bolts B1, the shaft supporting housing 13 is connected to the peripheral wall 12b of the motor housing 12 and the discharge housing 14 is connected to the flange wall 19 of the shaft supporting housing 13. Accordingly, the motor housing 12, the shaft supporting housing 13, and the discharge housing 14 are arranged in this order in the axial direction of the rotary shaft 15. The fixed scroll 25 is held between the end wall 14a of the discharge housing 14 and the shaft supporting housing 13. Thus, the fixed scroll 25 is fixed to the housing 11.

The scroll compressor 10 includes a suction passage 35. The suction passage 35 has a first groove 36, a first hole 37, a second groove 38, and a second hole 39. The first groove 36 is formed in a portion of the inner peripheral surface of the peripheral wall 12b of the motor housing 12. The first groove 36 is opened in an open end of the peripheral wall 12b. The first hole 37 is formed in the outer peripheral portion of the flange wall 19 of the shaft supporting housing 13. The first hole 37 extends through the flange wall 19 in the thickness direction thereof. The first hole 37 communicates with the first groove 36. The second groove 38 is formed in a portion of an inner peripheral surface of the peripheral wall 14b of the discharge housing 14. The second groove 38 communicates with the first hole 37. The second hole 39 is formed in the fixed scroll outer peripheral wall 25c of the fixed scroll 25. The second hole 39 extends through the fixed scroll outer peripheral wall 25c in a thickness direction thereof. The second hole 39 communicates with the second groove 38. The second hole 39 communicates with an outermost peripheral portion of the compression chamber 27.

The refrigerant in the motor chamber 20 flows through the first groove 36, the first hole 37, the second groove 38, and the second hole 39, and is sucked into the compression chamber 27. The refrigerant sucked into the compression chamber 27 is compressed in the compression chamber 27 by the orbiting motion of the orbiting scroll 26. Thus, the compression mechanism C1 compresses the refrigerant sucked into the housing 11.

The scroll compressor 10 includes a discharge chamber 40. The discharge chamber 40 is defined between the fixed scroll base plate 25a and the end wall 14a of the discharge housing 14. The discharge chamber 40 communicates with the discharge port 25h. The refrigerant compressed in the compression chamber 27 is discharged into the discharge chamber 40. The discharge housing 14 has a discharge port 14h. That is, the housing 11 has the discharge port 14h. The discharge port 14h is formed in the end wall 14a of the discharge housing 14. The discharge port 14h communicates with the discharge chamber 40. The refrigerant in the discharge chamber 40 is discharged through the discharge port 14h to an outside of the scroll compressor 10.

A back pressure chamber 45 is defined between the orbiting scroll base plate 26a of the orbiting scroll 26 and the shaft supporting housing 13. The back pressure chamber 45 is formed on a side opposite from the fixed scroll base plate 25a relative to the orbiting scroll base plate 26a in the housing 11. Thus, the back pressure chamber 45 is formed between the base plate end surface 26f and the shaft supporting housing 13. The shaft supporting housing 13 separates the back pressure chamber 45 from the motor chamber 20. The inside of the peripheral wall 18 of the shaft supporting housing 13 is a part of the back pressure chamber 45. A gap between the elastic plate 31 and the shaft supporting housing 13 is also a part of the back pressure chamber 45.

The scroll compressor 10 includes an air supply passage 46. The air supply passage 46 is formed in the orbiting scroll 26. A first end of the air supply passage 46 is opened in a distal end of the orbiting scroll spiral wall 26b. The first end of the air supply passage 46 is capable of communicating with the compression chamber 27. A second end of the air supply passage 46 is opened in a bottom surface 47a that defines the recess 47. The second end of the air supply passage 46 communicates with the back pressure chamber 45. The air supply passage 46 extends through an inner end portion of the orbiting scroll spiral wall 26b that is formed in a spiral shape extending radially inwardly toward a center of the orbiting scroll 26, and the orbiting scroll base plate 26a. The air supply passage 46 is a through hole having a circular hole shape.

A part of the refrigerant compressed in the compression chamber 27 is supplied to the back pressure chamber 45 through the air supply passage 46. As a result, pressure in the back pressure chamber 45 is higher than that in the motor chamber 20. As the pressure in the back pressure chamber 45 increases, the orbiting scroll base plate 26a is urged toward the fixed scroll base plate 25a so that the distal end of the orbiting scroll spiral wall 26b is pressed against the fixed scroll base plate 25a. Thus, the refrigerant for urging the orbiting scroll base plate 26a toward the fixed scroll base plate 25a is introduced into the back pressure chamber 45.

In addition, oil in the refrigerant is supplied together with the refrigerant to the back pressure chamber 45 through the air supply passage 46. Accordingly, the air supply passage 46 also serves as an oil supply hole for supplying the oil to the back pressure chamber 45. Thus, the oil supply hole that is opened toward the back pressure chamber 45 and through which the oil is supplied to the back pressure chamber 45 is formed in the orbiting scroll 26. The air supply passage 46 as the oil supply hole is opened in the bottom surface 47a that defines the recess 47.

The rotary shaft 15 includes an eccentric shaft 50. The eccentric shaft 50 protrudes from the distal end 15e of the rotary shaft 15 and extends in parallel with the rotary shaft 15 at a position offset from a center axial line L1 of the rotary shaft 15. The eccentric shaft 50 is formed integrally with the rotary shaft 15. An axial direction of the eccentric shaft 50 coincides with the axial direction of the rotary shaft 15. The eccentric shaft 50 protrudes from the distal end 15e of the rotary shaft 15 toward the orbiting scroll 26. The eccentric shaft 50 is inserted into the recess 47.

### Bushing

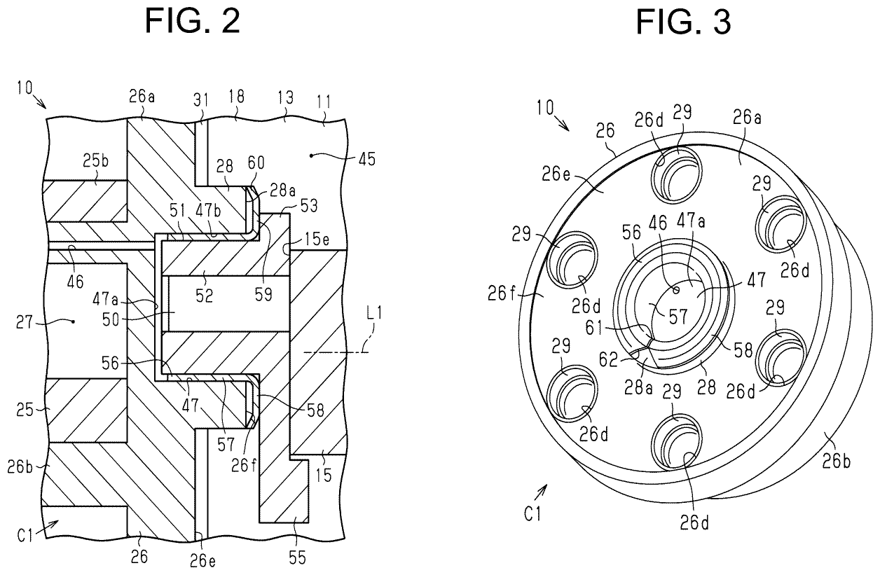

As illustrated in FIG. 2, the eccentric shaft 50 is inserted into a bushing 51. The bushing 51 has a bushing tubular portion 52 and a bushing flange portion 53. The eccentric shaft 50 is inserted into the bushing tubular portion 52. The bushing tubular portion 52 is disposed inside the recess 47. That is, the bushing 51 is disposed in the recess 47.

An end portion of the bushing tubular portion 52 opposite from the orbiting scroll base plate 26a extends out from the boss portion 28. The bushing flange portion 53 is formed in an annular shape protruding outwardly from the end portion of the bushing tubular portion 52 opposite from the orbiting scroll base plate 26a. The bushing flange portion 53 protrudes outwardly from the bushing tubular portion 52 in the radial direction of the rotary shaft 15. The bushing flange portion 53 is overlapped with the distal end surface 28a of the boss portion 28 in the axial direction of the boss portion 28. The bushing 51 is swingable about the eccentric shaft 50.

The scroll compressor 10 includes a balance weight 55. The balance weight 55 is formed integrally with the bushing 51. The balance weight 55 protrudes outwardly from a portion of an outer peripheral surface of the bushing flange portion 53. The balance weight 55 is accommodated inside the peripheral wall 18 of the shaft supporting housing 13.

### Plain Bearing

A plain bearing 56 is disposed on an inner peripheral surface 47b that defines the recess 47. The plain bearing 56 has a tubular shape. The plain bearing 56 is formed by curving a strip-shaped plate material made of metal in an arc shape. That is, the plain bearing 56 does not have an annular shape.

The plain bearing 56 has a bearing tubular portion 57 and a bearing flange portion 58. The bearing tubular portion 57 is disposed on the inner peripheral surface 47b of the recess 47. The bearing tubular portion 57 is disposed between the inner peripheral surface 47b of the recess 47 and the outer peripheral surface of the bushing tubular portion 52. The bushing tubular portion 52 is disposed inside the plain bearing 56. The plain bearing 56 rotatably supports the bushing 51.

An end portion of the bearing tubular portion 57 opposite from the orbiting scroll base plate 26a extends out from the recess 47. The bearing flange portion 58 is formed in an annular shape protruding outwardly from the end portion of the bearing tubular portion 57 opposite from the orbiting scroll base plate 26a. The bearing flange portion 58 protrudes from the bearing tubular portion 57 outwardly in the radial direction of the rotary shaft 15. The bearing flange portion 58 is disposed between the distal end surface 28a of the boss portion 28 and the bushing flange portion 53. That is, the bearing flange portion 58 is disposed between the base plate end surface 26f and the bushing flange portion 53.

The bearing flange portion 58 has a first extending portion 59 and a second extending portion 60. The first extending portion 59 is formed in an arc shape extending from the bearing tubular portion 57 outwardly in the radial direction of the rotary shaft 15. The first extending portion 59 extends along the bushing flange portion 53. The first extending portion 59 is in contact with the bushing flange portion 53. The second extending portion 60 is formed in an arc shape extending and inclining from an end of the first extending portion 59 opposite from the bearing tubular portion 57 toward the base plate end surface 26f. The second extending portion 60 is in contact with the distal end surface 28a of the boss portion 28. That is, the second extending portion 60 is in contact with the base plate end surface 26f. The bearing flange portion 58 is in contact with the base plate end surface 26f and presses the orbiting scroll 26 against the fixed scroll 25, and also is in contact with the bushing flange portion 53 and presses the bushing 51 against the distal end 15e of the rotary shaft 15.

The rotation of the rotary shaft 15 is transmitted to the orbiting scroll 26 through the eccentric shaft 50, the bushing 51, and the plain bearing 56. This causes the orbiting scroll 26 to rotate on its own axis. Then, the pins 30 come into contact with inner peripheral surfaces of the ring members 29, which prevents the rotation of the orbiting scroll 26 on its own axis and only allows the orbiting scroll 26 to orbit. Thus, the orbiting scroll 26 orbits with the orbiting scroll spiral wall 26b in contact with the fixed scroll spiral wall 25b. A volume of the compression chamber 27 decreases with the orbiting motion of the orbiting scroll 26, so that the refrigerant is compressed in the compression chamber 27. The orbiting scroll 26 orbits inside the fixed scroll outer peripheral wall 25c with the rotation of the rotary shaft 15. The balance weight 55 cancels out a centrifugal force acting on the orbiting scroll 26 during the orbiting motion of the orbiting scroll 26. This reduces a degree of imbalance in the orbiting scroll 26.

### Groove

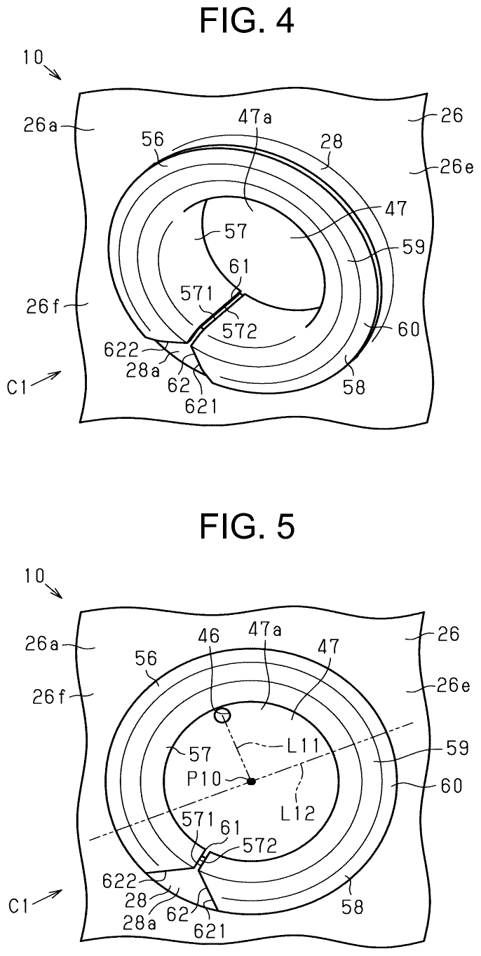

As illustrated in FIGS. 3 and 4, a groove 61 is formed in the bearing tubular portion 57. The groove 61 is formed between a first edge 571 of the bearing tubular portion 57 that is located on one side in a circumferential direction of the bearing tubular portion 57 and a second edge 572 of the bearing tubular portion 57 that is located on the other side in the circumferential direction of the bearing tubular portion 57. The groove 61 is a gap between the first edge 571 and the second edge 572. The groove 61 extends from a first edge to a second edge in an axial direction of the bearing tubular portion 57. The groove 61 extends so that the oil is supplied from the air supply passage 46 toward the bearing flange portion 58 through the groove 61.

As illustrated in FIG. 5, as viewed in the axial direction of the rotary shaft 15, a straight line connecting a center P10 of the recess 47 to the air supply passage 46 is defined as a first straight line L11. A straight line passing through the center P10 of the recess 47 and extending perpendicularly to the first straight line L11 is defined as a second straight line L12. Here, the air supply passage 46 is opened at a position opposite from the groove 61 across the second straight line L12 in the bottom surface 47a.

### Cutout

The bearing flange portion 58 has a cutout 62. The cutout 62 is formed of a first cutout edge 621 and a second cutout edge 622. The first cutout edge 621 is continuous with the first edge 571. The second cutout edge 622 is continuous with the second edge 572. That is, the cutout 62 communicates with the groove 61. The first cutout edge 621 connects the first edge 571 to an outer peripheral edge of the bearing flange portion 58. The second cutout edge 622 connects the second edge 572 to the outer peripheral edge of the bearing flange portion 58. A distance between the first cutout edge 621 and the second cutout edge 622 increases as the first cutout edge 621 and the second cutout edge 622 extend away from the groove 61. The cutout 62 is formed so that an angle between the first cutout edge 621 and the second cutout edge 622 is an obtuse angle when viewed in the axial direction of the rotary shaft 15. The cutout 62 extends across the first extending portion 59 and the second extending portion 60 when viewed in the axial direction of the rotary shaft 15. The oil is supplied to the outer peripheral edge of the bearing flange portion 58 through the cutout 62.

### Operation of Embodiment

The following will describe operation of the embodiment.

In such a scroll compressor 10, the bushing 51 may move toward the orbiting scroll 26 in the axial direction of the rotary shaft 15 between the distal end 15e of the rotary shaft 15 and the orbiting scroll 26. When the bushing 51 moves toward the orbiting scroll 26 in the axial direction of the rotary shaft 15 between the distal end 15e of the rotary shaft 15 and the orbiting scroll 26, the bushing flange portion 53 comes into contact with the bearing flange portion 58. Accordingly, even when the bushing 51 moves toward the orbiting scroll 26 in the axial direction of the rotary shaft 15 between the distal end 15e of the rotary shaft 15 and the orbiting scroll 26, the bushing 51 is prevented from coming into contact with the orbiting scroll 26. This avoids a problem that the bushing 51 comes into contact with the orbiting scroll 26 to cause abrasion between the orbiting scroll 26 and the bushing 51.

The groove 61 is formed in the bearing tubular portion 57 and extends so that the oil is supplied from the air supply passage 46 toward the bearing flange portion 58 through the groove 61. Accordingly, the oil from the air supply passage 46 is easily supplied to the bearing flange portion 58 through the groove 61. The cutout 62 through which the oil is supplied toward the outer peripheral edge of the bearing flange portion 58 is formed in the bearing flange portion 58 and communicates with the groove 61. Accordingly, the oil supplied to the bearing flange portion 58 through the groove 61 is easily supplied to the outer peripheral edge of the bearing flange portion 58 through the cutout 62. As a result, even when the bushing flange portion 53 comes into contact with the bearing flange portion 58, there is good lubrication between the bearing flange portion 58 and the bushing flange portion 53.

### Advantageous Effect of Embodiment

The present embodiment provides the following advantageous effects.
(1) When the bushing 51 moves toward the orbiting scroll 26 in the axial direction of the rotary shaft 15 between the distal end 15e of the rotary shaft 15 and the orbiting scroll 26, the bushing flange portion 53 comes into contact with the bearing flange portion 58. Accordingly, even when the bushing 51 moves toward the orbiting scroll 26 in the axial direction of the rotary shaft 15 between the distal end 15e of the rotary shaft 15 and the orbiting scroll 26, the bushing 51 is prevented from coming into contact with the orbiting scroll 26. This avoids the problem that the bushing 51 comes into contact with the orbiting scroll 26 to cause abrasion between the orbiting scroll 26 and the bushing 51. Therefore, for example, there is no need to separately provide a component for restricting the moving of the bushing 51 toward the orbiting scroll 26 in the axial direction of the rotary shaft 15 and to separately provide a component with high abrasion resistance between the bushing 51 and the orbiting scroll 26 in the axial direction of the rotary shaft 15, other than the plain bearing 56.

The groove 61 is formed in the bearing tubular portion 57 and extends so that the oil is supplied from the air supply passage 46 toward the bearing flange portion 58 through the groove 61. Accordingly, the oil from the air supply passage 46 is easily supplied to the bearing flange portion 58 through the groove 61. The cutout 62 through which the oil is supplied toward the outer peripheral edge of the bearing flange portion 58 is formed in the bearing flange portion 58 and communicates with the groove 61. Accordingly, the oil supplied to the bearing flange portion 58 through the groove 61 is easily supplied to the outer peripheral edge of the bearing flange portion 58 through the cutout 62. As a result, even when the bushing flange portion 53 comes into contact with the bearing flange portion 58, there is good lubrication between the bearing flange portion 58 and the bushing flange portion 53. As described above, in the scroll compressor 10 of the present embodiment, durability of the scroll compressor 10 is improved without increasing the number of components.
(2) The air supply passage 46 is opened at a position opposite from the groove 61 across the second straight line L12 in the bottom surface 47a of the recess 47. This increases a distance between the air supply passage 46 and the groove 61 as much as possible, so that the oil from the air supply passage 46 is easily supplied to an inner peripheral surface of the bearing tubular portion 57. As a result, there is good lubrication between the bearing tubular portion 57 and the bushing tubular portion 52. Accordingly, the durability of the scroll compressor 10 is further improved.
(3) The bearing flange portion 58 is in contact with the base plate end surface 26f and presses the orbiting scroll 26 against the fixed scroll 25, and is in contact with the bushing flange portion 53 and presses the bushing 51 against the distal end 15e of the rotary shaft 15. This positions the bushing 51 in the axial direction of the rotary shaft 15. Accordingly, it is suppressed that the bushing 51 moves in the axial direction of the rotary shaft 15 between the distal end 15e of the rotary shaft 15 and the orbiting scroll 26.
(4) The bearing flange portion 58 has the first extending portion 59 and the second extending portion 60. The first extending portion 59 is formed in the arc shape extending from the bearing tubular portion 57 outwardly in the radial direction of the rotary shaft 15 and is in contact with the bushing flange portion 53. The second extending portion 60 is formed in the arc shape extending and inclining from the end of the first extending portion 59 opposite from the bearing tubular portion 57 toward the base plate end surface 26f and is in contact with the base plate end surface 26f. This configuration is suitable for positioning the bushing 51 in the axial direction of the rotary shaft 15.
(5) There is no need to separately provide the component with high abrasion resistance between the bushing 51 and the orbiting scroll 26 in the axial direction of the rotary shaft 15, other than the plain bearing 56, so that the scroll compressor 10 may be decreased in size in the axial direction of the rotary shaft 15.

### Modified Example

The above-described embodiment may be modified as follows. The above-described embodiment and the following modified examples can be combined as long as they do not contradict each other.

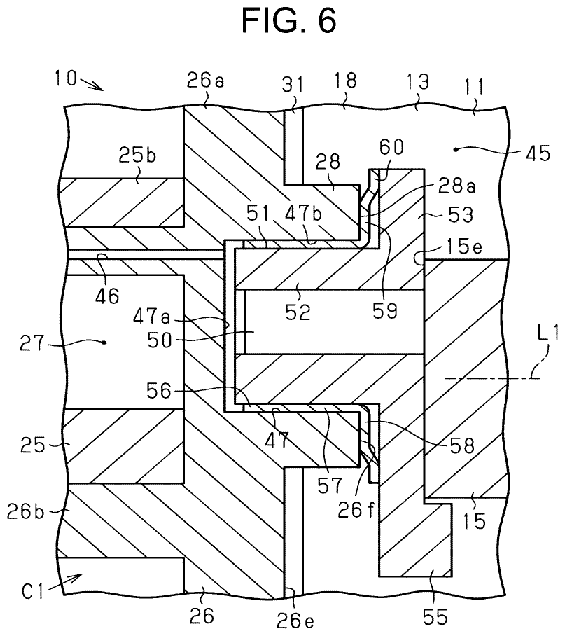

As illustrated in FIG. 6, the first extending portion 59 may be formed in an arc shape extending from the bearing tubular portion 57 outwardly in the radial direction of the rotary shaft 15 and may be in contact with the base plate end surface 26f, and the second extending portion 60 may be formed in an arc shape extending and inclining from the end of the first extending portion 59 opposite from the bearing tubular portion 57 toward the bushing flange portion 53 and may be in contact with the bushing flange portion 53. This configuration is suitable for positioning the bushing 51 in the axial direction of the rotary shaft 15.

In the embodiment, the bearing flange portion 58 need not press the orbiting scroll 26 against the fixed scroll 25 and need not press the bushing 51 against the distal end 15e of the rotary shaft 15.

In the embodiment, the air supply passage 46 may be opened at a position closer to the groove 61 than the second straight line L12 in the bottom surface 47a of the recess 47.

In the embodiment, the angle of the cutout 62 between the first cutout edge 621 and the second cutout edge 622 may be an acute angle when viewed in the axial direction of the rotary shaft 15.

In the embodiment, the cutout 62 may extend from the second extending portion 60 when viewed in the axial direction of the rotary shaft 15.

In the embodiment, a shape of the cutout 62 is not particularly limited as long as the cutout 62 communicates with the groove 61 and the oil is supplied toward the outer peripheral edge of the bearing flange portion 58 through the cutout 62.

In the embodiment, the plain bearing 56 does not have the annular shape and is formed by curving the strip-shaped plate material made of metal; however, the plain bearing 56 is not limited thereto, and may have an annular shape that extends over its entire circumference. In this case, the groove 61 only needs to be formed by recessing a part of the inner peripheral surface of the bearing tubular portion 57 and extend so that the oil is supplied from the air supply passage 46 toward the bearing flange portion 58 through the groove 61.

In the embodiment, the eccentric shaft 50 need not be formed integrally with the rotary shaft 15 and may be provided separately from the rotary shaft 15. In this case, the eccentric shaft 50 is attached to the distal end 15e of the rotary shaft 15.

In the embodiment, the first end of the air supply passage 46 may be opened in the end surface of the orbiting scroll base plate 26a that is located closer to the orbiting scroll spiral wall 26b, and the air supply passage 46 may be formed in the orbiting scroll 26 so as to extend only through the orbiting scroll base plate 26a.

In the embodiment, the balance weight 55 may be provided separately from the bushing 51.

In the embodiment, the scroll compressor 10 need not be driven by the motor 22, and for example, the scroll compressor 10 may be driven by an engine of the vehicle.

In the embodiment, the scroll compressor 10 is used in the vehicle air conditioner; however, the present disclosure is not limited thereto. In short, the scroll compressor 10 only needs to compress the refrigerant, and may be used for various applications.

In the embodiment, an object to be compressed by the scroll compressor 10 is not limited to the refrigerant, and for example, may be a fluid such as air.

What is claimed is:

1. A scroll compressor comprising:
a housing having a suction port through which a refrigerant is sucked and a discharge port through which the refrigerant is discharged;
a rotary shaft accommodated in the housing and rotatably supported by the housing; and
a compression mechanism having a fixed scroll that is fixed to the housing and an orbiting scroll that orbits with rotation of the rotary shaft,
the rotary shaft having an eccentric shaft that protrudes from a distal end of the rotary shaft and extends in parallel with the rotary shaft at a position offset from a center axial line of the rotary shaft,
the fixed scroll having a fixed scroll base plate, a fixed scroll spiral wall that protrudes from the fixed scroll base plate, and a fixed scroll outer peripheral wall that protrudes from the fixed scroll base plate and surrounds the fixed scroll spiral wall,
the orbiting scroll having an orbiting scroll base plate that faces the fixed scroll base plate and an orbiting scroll spiral wall that protrudes from the orbiting scroll base plate toward the fixed scroll base plate and orbits inside the fixed scroll outer peripheral wall,
the compression mechanism having a compression chamber that is defined by the fixed scroll base plate, the fixed scroll spiral wall, the orbiting scroll base plate, and the orbiting scroll spiral wall and in which the refrigerant is compressed by meshing the fixed scroll spiral wall with the orbiting scroll spiral wall,
the housing having a shaft supporting housing that is disposed on a side opposite from the fixed scroll base plate relative to the orbiting scroll base plate and supports the rotary shaft,
the refrigerant being introduced into a back pressure chamber that is formed between a base plate end surface of the orbiting scroll base plate opposite from the fixed scroll base plate and the shaft supporting housing, the refrigerant urging the orbiting scroll base plate toward the fixed scroll base plate,
the orbiting scroll having an oil supply hole that is opened toward the back pressure chamber and through which oil is supplied to the back pressure chamber,
the eccentric shaft being inserted into a bushing that is swingable about the eccentric shaft,
the base plate end surface having a recess formed in a bottom tubular shape in which the bushing is disposed,
the recess being defined by an inner peripheral surface on which a plain bearing rotatably supporting the bushing is disposed,
the recess being defined by a bottom surface in which the oil supply hole is opened,
the bushing having a bushing tubular portion that is disposed inside the plain bearing, and
the plain bearing having a bearing tubular portion that is disposed inside the inner peripheral surface, wherein
the bushing has a bushing flange portion that protrudes from the bushing tubular portion outwardly in a radial direction of the rotary shaft,
the plain bearing has a bearing flange portion that protrudes from the bearing tubular portion outwardly in the radial direction and that is disposed between the base plate end surface and the bushing flange portion,
a groove is formed in the bearing tubular potion and extends so that the oil is supplied from the oil supply hole toward the bearing flange portion through the groove, and
a cutout through which the oil is supplied toward an outer peripheral edge of the bearing flange portion is formed in the bearing flange portion and communicates with the groove.

2. The scroll compressor according to claim 1, wherein
when viewed in an axial direction of the rotary shaft, a straight line connecting a center of the recess to the oil supply hole is defined as a first straight line and a straight line passing through the center of the recess and extending perpendicularly to the first straight line is defined as a second straight line, and
the oil supply hole is opened at a position opposite from the groove across the second straight line in the bottom surface.

3. The scroll compressor according to claim 1, wherein
the bearing flange portion is in contact with the base plate end surface and presses the orbiting scroll against the fixed scroll, and is in contact with the bushing flange portion and presses the bushing against the distal end of the rotary shaft.

4. The scroll compressor according to claim 3, wherein
the bearing flange portion has:
a first extending portion that is formed in an arc shape extending from the bearing tubular portion outwardly in the radial direction of the rotary shaft and is in contact with the bushing flange portion; and
a second extending portion that is formed in an arc shape extending and inclining from an end of the first extending portion opposite from the bearing tubular portion toward the base plate end surface and is in contact with the base plate end surface.

5. The scroll compressor according to claim 3, wherein
the bearing flange portion has:
a first extending portion that is formed in an arc shape extending from the bearing tubular portion outwardly in the radial direction of the rotary shaft and is in contact with the base plate end surface; and
a second extending portion that is formed in an arc shape extending and inclining from an end of the first extending portion opposite from the bearing tubular portion toward the bushing flange portion and is in contact with the bushing flange portion.
